(19) United States
(12) Patent Application Publication
(10) Pub. No.: US 2011/0230987 A1
(43) Pub. Date: Sep. 22, 2011

(54) Real-Time Music to Music-Video Synchronization Method and System

(75) Inventors: Xavier Anguera Miró, Madrid (ES); Robert Macrae, Madrid (ES); Nuria Oliver Ramírez, Madrid (ES); Xavier Amatriain Rubio, Madrid (ES)

(73) Assignee: TELEFONICA, S.A., Madrid (ES)

(21) Appl. No.: 13/014,099

(22) Filed: Jan. 26, 2011

Related U.S. Application Data
(60) Provisional application No. 61/312,808, filed on Mar. 11, 2010.

(51) Int. Cl. G06F 17/00

(52) U.S. Cl. 700/94

(57) ABSTRACT

Method, system and computer program for real time synchronizing an audio file and a video file in a multimedia device. The present invention determines the optimum alignment path between the audio signal of the audio file and the audio track signal of the video file, starting from an initial path and performing a post-alignment processing to improve the user satisfaction when playing.

### TECHNICAL FIELD

The present invention relates generally to real time audio sequences synchronization and more particularly to a system and method for real time online/offline music to video music synchronization in order to allow the users to combine music audio with its associated music video.

### DESCRIPTION OF THE PRIOR ART

In recent years, the popularity of compressible music files and online music downloads has increased dramatically. People have built large digital collections of high quality music on their computers and portable devices to be played in their homes or on the go. At the same time, music videos are being offered online both for free and through affordable monthly subscriptions.

Therefore, there is an opportunity and a challenge for combining high quality audio with its associated music video in order to provide a seamless high quality multimodal music experience to users.

In the literature, we have found two main approaches to tackling the problem of music to video alignment: (1) Audio to Video Matching, where the audio that comes with the video is not analysed. Hence, the problem is purely considered as that of a video to music alignment. The aim in this case is to find suitable video features that can be related and then aligned with the audio features in the music. This approach is useful when the content of the two media being combined is dissimilar; and (2) Audio to Audio Matching, where only the audio channel in the video is analysed and standard audio to audio alignment methods are used in order to determine how to then warp the video to the song. Note that this type of alignment is only possible when the audio in the video matches the music.

There have been a number of research projects aimed at aligning audio and video tracks to synchronise background music, in an off-line fashion, for sports videos, home videos and amateur music videos. These methods involve extracting suitable video features that are matched to a comparable set of features from the audio channel in order to align them. The general purpose of these methods is to find appropriate segments within the two sources which helps avoid the problem of structural differences within the two recordings. However, there is not any bias in following a linear progression through both recordings that might be desirable in this case.

In audio-to-audio alignment, a common approach is to synchronise both signals by means of either beat-tracking, Hidden Markov Models (HMMs) or Dynamic Time Warping (DTW) techniques. Unlike audio to video matching techniques, these audio to audio methods usually assume that the start time of both pieces is known. Real-time systems, such as those used in speech recognition, tend to use HMMs to calculate likelihood states from observed features such as Mel Frequency Cepstral coefficients (MFCC). HMMs require training on suitable data to learn the model parameters (probabilities). This approach has been used to synchronise music with scores, lyrics and also for video segmentation, among others. Conversely, Dynamic Time Warping (DTW) is typically used to find the best alignment path between two audio pieces in an offline context. However, the cost of computing the accumulated cost matrix and later the path through this matrix does not scale efficiently for large sequences. Over the years there have been a number of efforts to improve the efficiency of DTW, as well as variations in the local constraints imposed on the dynamic programming finding algorithm. A major drawback of the standard DTW approach is that it requires knowledge of both the start and end points of the sequences to align, which doesn't lend itself to synchronising sequences with possibly non-matching segments at the start or end. Similarly, one could use a pre-computed offline alignment, store the warping path and use it later, when playing the music video, to warp the video in real time. For example, the Sync Player system uses an offline DTW alignment with pre-computed alignment paths in order to provide metadata (scores and lyrics) in sync with the music that the user is playing. However, Dixon in “Live tracking of musical performances using on-line time warping. In Proceedings of the 8th International Conference on Digital Audio Effects, pages 92-97, Madrid, Spain, 2005” has shown it is possible to perform DTW in real time. This method, called Online Time Warping (OTW), combines slope constraints with an iterative and a progressive DTW method such that it can synchronise two audio files or one audio file to live music.

The existing synchronization algorithms have two problems in general:
Some of the algorithms need to know the start and/or end times where the two signals are in synch, processing then the alignment between these points.
Some of the other algorithms have a high processing complexity that does not allow them to do the alignment online. Also, in some cases they need to have the whole signal beforehand to start the alignment.

A similar algorithm to the present invention is proposed in S. Dixon “Live tracking of musical performances using on-line time warping. In Proceedings of the 8th International Conference on Digital Audio Effects, pages 92-97, Madrid, Spain, 2005” which conducts an online alignment not knowing the end point. It needs to know though the starting point to perform the alignment, therefore it does not work for the case presented here, where we are asking a video feed to be synchronized with the audio once this has already started.

### SUMMARY OF THE INVENTION

The present invention proposed here is a synchronization algorithm that allows synchronizing high quality music with the counterpart music video file (through its audio track) by a) finding the initial synchronization point where both are initially aligned; and b) doing then an online alignment to ensure that both songs remain aligned throughout the song. Additionally, an extra post processing is done to the obtained alignments to ensure that the user visualizing the video will see it smoothly. The output of this invention is that the video plays back totally synchronized to the audio.

In a first aspect, a method for real time synchronizing an audio file and a video file in a multimedia device, determining an optimum alignment path between the audio signal of the audio file and the audio track signal of the video file is proposed. The method comprising the following steps:
Retrieving and initial buffer of the audio signal of the audio file and the audio track signal of the video file
Computing the chroma features of the buffered signals and generating a sequence of first feature vectors U:=u₁; u₂; . . . ; u_{M}) and second feature vectors V:=(v₁; v₂; ; v_{N}) for the audio signal and the audio track signal of the video file respectively
Finding an initial alignment path Pᵢ=(pᵢ₁ . . . pᵢₖ), between the buffered signals U and V, any path point pᵢⱼ is defined by a pair (mᵢⱼ; nᵢⱼ) which indicates that frames uₘᵢ and vₙᵢ form part of the aligned path.
Starting from the last point of the initial path, p_{w}:=pᵢₖ, and W:=k, apply the following algorithm to obtain an optimum alignment path P. Initially P=Pᵢ:
   1. Using the feature sequences of the signals buffered til this moment, computing a forward path P_{f}:=(p_{f1} . . . p_{fL}) with length L by minimizing a defined global cost, starting at position p_{f1}=p_{w}, where L is a designed parameter.
   2. An standard DTW algorithm in which a path with minimizes a defined global cost is found, is applied with starting point p_{fL} and final point p_{f1}. The first half of this path is appended to the optimum path and W=W+L/2
   3. If none of the signals has finished, back to step 1
During the algorithm continuing buffering the signals, computing their chroma features and using them for steps 1 and 2.
Once the optimum alignment path is obtained, smoothing this path, minimizing the jumps between alignment points

In another aspect, a system comprising means adapted to perform the above-described method is presented.

Finally, a computer program comprising computer program code means adapted to perform the above-described method is presented.

For a more complete understanding of the invention, its objects and advantages, reference may be had to the following specification and to the accompanying drawings.

### BRIEF DESCRIPTION OF THE DRAWINGS

To complete the description and in order to provide for a better understanding of the invention, a set of drawings is provided. Said drawings form an integral part of the description and illustrate a preferred embodiment of the invention, which should not be interpreted as restricting the scope of the invention, but rather as an example of how the invention can be embodied. The drawings comprise the following figures:

FIG. 1 represents the local path constraints for forward path for initial path discovery (a) and backward path for online alignment (b).

FIG. 2 shows an example of the post processing smoothing step

FIG. 3 shows an example of the results of the present invention applied to Beyonce's “If I were a Boy” showing an extra video section.

FIG. 4 shows a graphic comparing the durations for the matching of audio and video files.

FIG. 5 shows a graphic showing the spread of start time differences.

FIG. 6 shows the accuracy and time taken to find the initial path versus the buffer length when applying the present invention.

Corresponding numerals and symbols in the different figures refer to corresponding parts unless otherwise indicated.

### DETAILED DESCRIPTION OF THE INVENTION

Existing audio-to-audio alignment methods are partly suitable because the audio to be aligned corresponds to the same content in both sources (music and music video). However, to fulfil our objectives of synchronising music videos with audio and providing smooth playback in real-time, the present invention proposed a few modifications to a standard DTW algorithm. Specifically, the paths are calculated in an iterative, progressive manner that allows for the end point to be unknown, as it is dependent on future audio content not yet received. These progressive steps are guided by an efficient forward path-finding algorithm, that is also used to compare and discover the correct starting position. Also, rather than computing the entire similarity matrix of frame by frame difference costs, only the likely pairs that the paths may traverse are calculated.

Given an input audio S₁ (e.g a music file) and a video file S₂ (e.g. a music video file) composed of a video track S₂ᵥ and an audio track S₂ₐ to be synchronised with S₁, the present invention proceeds in the following way (i.e. it involves the following steps):
Initial buffering/Audio features extraction: Retrieve an initial buffer of S₁ (e.g. 30-60 seconds) and S₂ₐ (e.g. 10-30 seconds) and compute their Chroma features.
Initial Path Discovery: Find, among the two pre-buffered signals, the most appropriated starting/initial points for the alignment using a multi-path selection approach. This allows for the algorithm to align two media sources even though their starting times do not coincide or their initial content is very different (very common in music videos).
Real-time online alignment: Continue computing feature vectors and follow an incremental DTW guided by a forward path selection, ensuring that both audio signals remain aligned during the whole duration of the audio track. That is, the alignment is done block-by-block, first with the initial buffered signals but during the processing the signals continue to arrive and being aligned.
Post-alignment processing: Apply a smoothing function to the alignment and use the average differences between the audio and video to update the video playback, to improve the user satisfaction when playing.

Two user cases are considered:
The system is a standalone application or a plug-in in a desktop computer or set top box where the user is able to synchronize the music files he has locally with music videos that he either has locally or that he is streaming in real time from the internet (either from free services like YouTube or from subscription-based services).
An application in the phone where the input audio is recorded life from the microphone and the video to be aligned can be in the cell phone's memory or downloaded on-the-fly from the internet, in the same way as before.

The challenge for a real-time DTW method, as opposed to offline, is in not having complete information, i.e. the full similarity matrix. Without the full similarity matrix, the DTW path is no longer guaranteed to be optimal and therefore the accuracy of the alignment may be adversely affected. Hence, the goal for the real-time DTW alignment is to equal that of a standard offline DTW method. Next, the theory behind the standard DTW algorithm is described as it is one of the basis for our invention.

Given two feature sequences U:=(u₁; u₂; . . . ; u_{M}) and V:=(v₁; v₂; . . . ; v_{N}), the standard DTW algorithm finds the optimum path through the cost matrix S(m; n) with mε[1: M] and nε[1: N] for given starting and end points. The metric used in the cost matrix varies depending on the implementation: the Euclidean distance (the path represents the minimum average cost) or the inner product similarity (the path represents the maximum average similarity) are among the two most common metrics. In this embodiment, we will use a normalised inner product distance, which gives a value of 0 when both frames are identical, as given by:

$$d U , V ( m , n ) = 1 - \frac{〈 {u}_{m} , {v}_{n} 〉}{‖ {u}_{m} ‖ ‖ {v}_{n} ‖}$$

The result of the DTW algorithm is a minimum cost path P:=(p₁; p₂; . . . ; p_{L}) of length L, where each pₖ:=(mₖ; nₖ) indicates that frames uₘₖ and vₙₖ are part of the aligned path at position k. The optimal P is chosen so that it minimises (or maximises, depending on the metric chosen) the overall cost function D(P)=Σₖ₌₁^{L}dU,V(mk,nk) and satisfies the following conditions:
Boundary condition: p₁=(1; 1) and p_{L}=(M; N)
Monotony condition: mₖ₊₁≧mₖ and nₖ₊₁≧nₖ for all kε[1; L].

Additionally, local constraints are imposed that define the values that (mk; nk) are allowed to take with respect to their neighbours, such as

(mₖ₋₁,nₖ₋₁=(mₖ+i,nₖ+j)|argmin{D(mₖ+i,nₖ+j)}

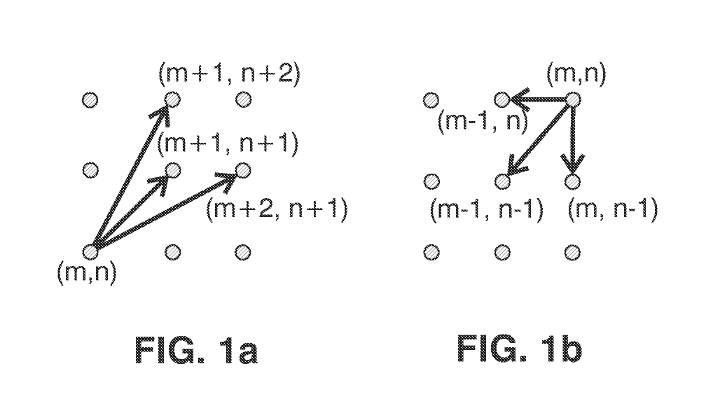

A common constraint is shown in FIG. 1b, where (i; j)ε{(0, −1); (−1,0); (−1, −1)}. The overall cost at any location (m, n) can be computed via dynamic programming as D(m, n)=d_{U,V}(m, n)+min[D(m−1, n); D(m−1; n−1); D(m; n−1)]. Other commonly used local constraints may be used.

The computation of the cost matrix S(m; n) for all values of m and n has a quadratic cost with respect to the length of the feature sequences U and V. For this reason, global constraints are usually applied that bound how far from the main diagonal the minimum cost path is allowed to go. The most common global constraints are the Sakoe-Chiva and the Itakura bounds.

### Audio Features Extraction

In order to do the synchronization, the two sequences of audio S₁ and S₂ₐ are divided into overlapping frames with a hop size of 100 ms for example, preferably windowed with a Hamming window, and then transformed into the frequency domain using a standard Fast Fourier Transform. The resulting spectrum is mapped onto a 12-dimensional normalized chroma representation. The 12 dimensions of the chroma bins correspond to the 12 notes found in western music. The effect of this mapping is to reduce the audio to that of a single octave. Chroma features are typically used in music alignment as they are robust to variations in how the music is played. Finally, the different costs between these chroma frames are calculated using the inner normalized product.

With an exemplary set of chroma features (features of two introductions of Leona Lewis' song Bleeding Love), the resulting similarity matrix has been computed with the vertical chroma representing the music file and the horizontal representing the audio track of the corresponding music video. The light points show the strong notes in the chroma frames and the strong matches in the similarity matrix. The horizontal video track contains an introduction that is not present in the audio only version. Therefore the optimal alignment starts at the end of this unequal introduction where-after it can be seen as a light diagonal line through the matrix. In order to ensure that our DTW method starts at an appropriately matching point, an initial path discovery algorithm is used to discover the strong starting positions.

### Initial Path Discovery

Due to the boundary condition associated with a typical DTW method, prior knowledge of the start and end coordinates is typically required in order to compute the optimal DTW path. In the case of real-time alignment (for example between songs and music videos), the end point is unknown and the start point of the music cannot be assumed to occur at the beginning of each source (there can be an unknown time offset from one to the other).

Therefore, the first step is to discover the starting point before making an estimate of the end point. To do so, a forward path finding algorithm, explained in the next paragraph, is implemented to discover an initial path Pi:=(pi1; pi2; . . . ; pi_{K}) of length K that corresponds to the optimum initial alignment between feature sequences U and V by minimising D(Pi). For this, we use the local constraints shown in FIG. 1a. The global cost D(m; n) at any location (m; n) can be found in our implementation as D(m; n)=d_{U,V} (m; n)+min[D(m−1; n−2), D(m−1; n−1), D(m−2; n−1)]. Note that although the min condition decides on location (m,n) with respect to positions earlier on in the path, the actual implementation of the system is done with a forward path selection where for each location (m,n) the next location added in that path is either (m+1, n+1), (m+1, n+2) or (m+2, n+1), whichever minimizes the global cost.

The condition shown above is followed by selecting the path with lowest overall cost whenever two paths collide in any location (m,n).

With this approach, the path is constrained by a minimum and maximum rate of 2 times and ½ times the original signal respectively.

In the forward path algorithm, in order to find the optimal starting position within a given initial buffer of the audio file U:=(u₁; u₂; . . . ; u_{M}) and the audio track of the video file V:=(v₁; v₂; . . . ; V_{N}), we compute the forward path for every possible position where either the audio or the video are at the initial frame i.e. (U1, Vn) with nε[1: N] or (Uₘ, V₁) with mε[1: M] (that is the first vector of the first signal with all the vectors of the second signal and all the vector of the first signal with the first vector of the second signal). Then a path selection procedure is applied in order to prune unsuitable initial paths:

a) after each path is progressed a step the algorithm eliminates all the paths whose overall cost is above the average cost of all the paths. Also, when two paths collide into the same location (m,n) the path with the highest overall cost is discarded.
b) With the remaining paths, progressing another step (best next point) and back to paragraph a).

It is worth noting that this selective process needs to be suspended during silent frames. Otherwise the noise of these frames would make the selection process random.

When there is only one path remaining, which typically occurs after approximately 275 ms of processing, it is assumed to be the correct alignment path and the real-time synchronisation is started from that point (initial path).

Note how this forward path finding algorithm differs from the standard method in two ways. Firstly, the path found is not guaranteed to be the optimal lowest cost path between two points, as it doesn't take into account all the possible paths through the local costs matrix. However it can be used as a rough guide for subsequent backward paths. Secondly, it is much quicker in discovering the forward path than standard methods. It is so efficient that we can afford to create many of these forward paths at various starting points within the similarity matrix, evaluate their overall path cost and select the optimum one.

### Real Time Online Alignment

Once the initial alignment Pi path has been found between the two acoustic signals, we proceed to the online synchronization to find the optimum alignment path P, ensuring that the playback of the video remains synchronized throughout the remaining of the song or audio file. Initially P:=(pᵢ₁), that is, the initial point of the initial path, with total length W=1 or initially P:=Pᵢ=(pᵢ₁; pᵢ₂; . . . ; pi_{K}) with W=k.

The online alignment algorithm cannot use a standard DTW algorithm applied to the full sequences of the acoustic signals files as the future acoustic data might be unknown to the system because the files might be not locally stored, but during this processing the signals of the files could be continuing arriving and being used and its computation would have quadratic costs. It uses instead a local variation of the standard DTW that allows an alignment to be made with linear costs.

The algorithm may start at the position where the initial alignment started its forward path, i.e, initially (p_{w}=pᵢ₁) and w=1 or at the position where the initial alignment ended (p_{w}=pᵢₖ) and W=k. From that point on, two steps are then alternated:
1. A forward path Pf:=(pf₁; pf₂; . . . ; pf_{L}) with length L is computed starting at position pf1=p_{w} and finding a final position pf_{L} To do so, a similar algorithm to the one used in searching for the initial alignment is used. In this case the starting point is fixed and only one path is computed forward with length L. For each position p_{fs} the next position is chosen according to the local contraints shown in FIG. 1a, so for each position p_{fs}:=(m_{fs}; n_{fs}), the next position p_{fs+1}, will be obtained, selecting from this three possible values of p_{fs+1}, (m_{fs}+1, n_{fs}+1), (m_{fs}+1, n_{fs}+2), (m_{fs}+2, n_{fs}+1), the one which minimizes the global cost function D.
2. A standard DTW is computed from pf_{L} to pf1 to find a backward path Pb, whose first half is appended to P and

$$W = W + \frac{L}{2} .$$

In the first step, a forward path P_{f} is found using the same local constraint as explained before until L matching elements are found. In our experiments, L is set to 50 frames (5 seconds). The obtained path is a sub-optimal alignment between both signals but it is useful to obtain a good estimate for the end position at distance L. In the first instance of this step, the last point pᵢₖ in the initially discovered path is used.

Then a conventional DTW path is calculated backwards from p_{fL} to pₙ. To do so, the accumulated cost matrix S(m, n) needs to be computed for mε[m_{f1}:m_{fL}] and nε[n_{f1}: n_{fL}] which is only a small portion of the cost matrix for the entire segments. Here the type of local constraint shown in FIG. 1b is used. This results in a backward path of P_{b}:=(p_{b1}; P_{b2}; . . . ; p_{bL}) that contains the optimal alignment between both signals at that time segment. From this backward path, the first half, P′_{b}:=(p_{b1}; p_{b2}; . . . ; p_{b1/2L}) is appended to the end of the final alignment path P resulting in an extended final path with a new length W=W+½L. This allows subsequent forward paths to benefit from how the reverse DTW path through the accumulated costs can overcome short areas of high cost and pick the best path to the given point. Additionally, vertical and horizontal movement is possible, bounded by the guiding forward path, giving the system some flexibility in adjusting to pauses in either of the sources.

Next, another forward path P_{f} is started where p_{f1}=p_{w}=p_{wantiguo}+½_{L} and so on until the end of either source is reached, that is, once the audio in either of the source is finished. During the processing of the online alignment the signals are continuing arriving and being aligned, i.e. even though the process starts with an initial buffered signal, during all the processing the signals are being received and buffered to be processed with this algorithm. From this final alignment, post-processes are applied to smooth the path in order to avoid the video jumping about, and therefore ensure an enjoyable experience to the users.

### Post Alignment Smoothing

As the rate at which acoustic frames are aligned is usually 10 times per second and the video playback is usually 25 or 30 frames per second, we might encounter that the obtained path P contains some jumps between alignment points. A post-alignment smoothing is applied in order to reduce these artefacts.

To avoid any quantisation effects, the final path is smoothed by extrapolating its points so that for any point during the music there is a corresponding time (in milliseconds) of where the video should be. Also, as the processing of the alignment in the online case can only be done with real-time data, we use the smoothed path to obtain a projected estimate of the alignment warping between the signals. This estimate is modified every time we compute new alignments and applied in the next signal block.

Every time the video is updated with a new frame, e.g. 30 times a second, the difference (in milliseconds) between the video and the audio is computed by the projected alignment path, this is equivalent to where the video should be in relation to the audio (i.e. +3200 ms). Then, the time differences are smoothed by averaging all the differences over, for example, the last 5 seconds. If the average difference (where the video should be in relation to the audio) differs from the video's actual difference (as known by the media player) by more than a certain threshold, for example, 35 ms (or one frame), video frames are skipped or replayed until the correct difference between the video and audio is reached.

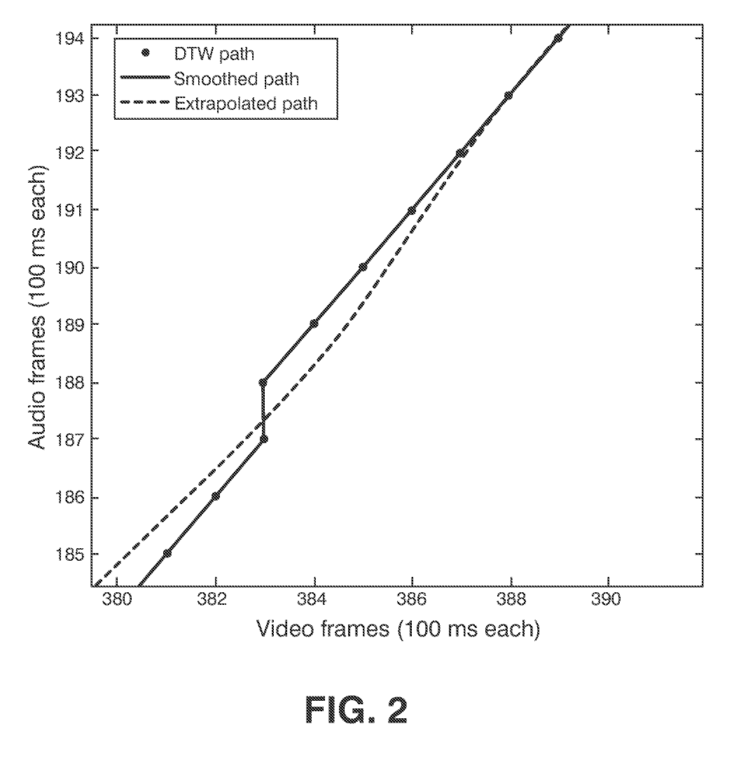

An example of this post-processing step is depicted in FIG. 2. The initially computed DTW alignment points are represented by circles. These points are limited to take values that are a multiple of the alignment step sizes. In order to obtain an alignment value for each video frame, we first extrapolate these points as seen in the light line connecting them. Finally and in order to avoid synchronisation jumps like the one shown at frame 383 in the line, the path is smoothed (dark line in the plot).

In order to evaluate the proposed algorithms, MuViSync, a prototype multimedia application implemented in MAX/MSP, has been developed. MuViSync uses the FFMPEG library to process audio and video files and QuickTime to control the playback. Videos can either be in the MP4 format or downloaded directly from YouTube. The audio can be in any format accepted by FFMPEG.

In the typical MuViSync's graphical user interface, on the left side, there is the list of songs stored in the user's personal music library whereas the right side is the video playback area. The “Online” check box above the video playback area lets the user specify whether the video should be taken from the library or streamed from YouTube. A scroll bar at the bottom of the video allows the user to change the playback position which the video then follows. In case any errors are made in the alignment, two buttons (“Move Back” and “Move On”) are also included to allow users to change the playback location when they think the alignment is wrong. Pressing either of these buttons restarts the initial path discovery method, limited to regions before or after the current alignment respectively.

MuViSync works as follows: the user first selects an audio file and starts playing it. Whenever (s) he decides to include the music video in-sync with the audio, (s) he starts the synchronisation by clicking on the video screen. MuViSync then retrieves the appropriate video (from the user's video library or from YouTube) and starts the buffering process. If the process is off-line (i.e. the video is in the user's video library) then this buffer may include data ahead of the playback position, otherwise (i.e. the video is retrieved from the Internet in real-time) it is limited to what has been currently downloaded. The video playback will usually start after approximately 500 ms. This buffering time corresponds to the time it takes to compute the initial chroma features and apply the initial alignment discovery method. However, in the online case this time is also dependent on the network connection and the response of YouTube servers.

Evaluating alignment techniques is typically problematic as gathering test data usually requires hand annotating the alignment between the pieces. An alternative technique consists of generating matching pairs using MIDI or recordings and then modifying one of the two pieces with the aim of discovering the same modification during alignment. Both of these techniques suffer drawbacks in being time consuming or producing easily sync-able test data, respectively. To evaluate the accuracy of our synchronization method, we carried out a novel technique to automatically acquire test data using a supervised standard off-line DTW to create a “ground truth” alignment. Although this test-data would be biased in that it is pre-filtered to be more conducive to a warping method, the technique used here does not have the complete information that a standard off-line DTW method would have for the alignment, and it is the ability to overcome this disadvantage that we are interested in testing. As matching the accuracy of the standard off-line DTW is one of the requirements of our method, it was felt that for the purposes of this evaluation the DTW “ground truth” data would be appropriate.

First, a test set was built consisting of music videos available from YouTube and MP3 files. The initial set of downloaded files included 350 audio files with their corresponding YouTube music videos. In order to determine the ground truth alignments of this data, we applied a standard off-line DTW method. This off-line DTW method was manually supervised so that incorrect alignments were discarded. In addition, all correct alignments where the beginnings and endings were not musically equivalent (and hence were miss-alignments) were discarded. In practice this meant examining the audio, video and DTW paths and selecting the points where the matching music began and finished. In most cases both pieces started off with differing periods of non music that were not related to each other. These regions in the DTW were excluded from further analysis.

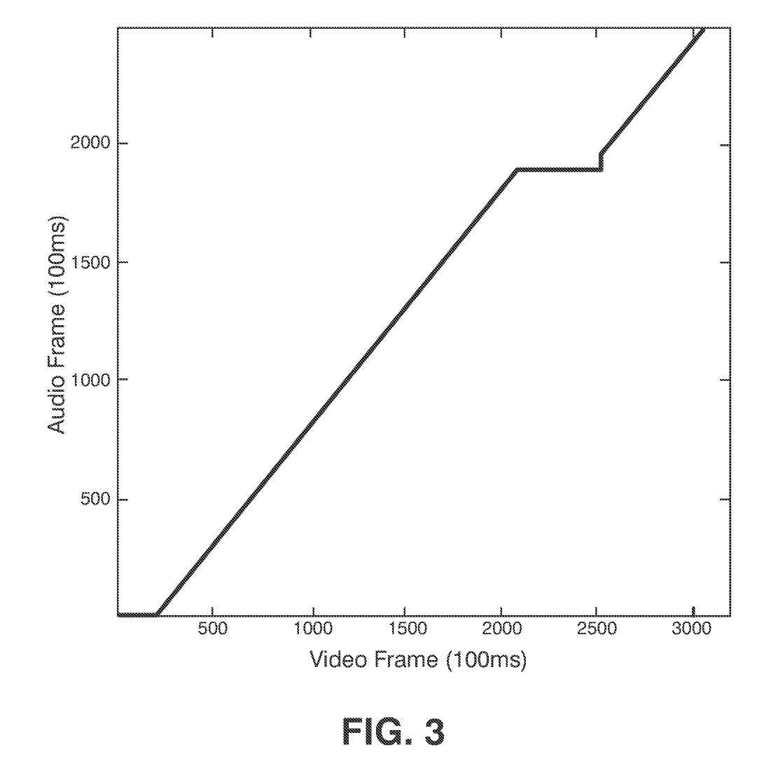

Finally, the test data-set was fixed to 320 sets of audio, video and online DTW alignment paths with which to evaluate our algorithm. From the data, we observed that in a few cases there were strong structural differences between both pieces. FIG. 3 shows an example of such a pair by highlighting the offline DTW path through the cost matrix between the audio piece from the MP3 file (vertical) and the audio from the movie video (horizontal). Such structural differences could cause discrepancies between the two alignments methods proposed as there are many possible ways to align the transitional states connecting matching segments in these cases.

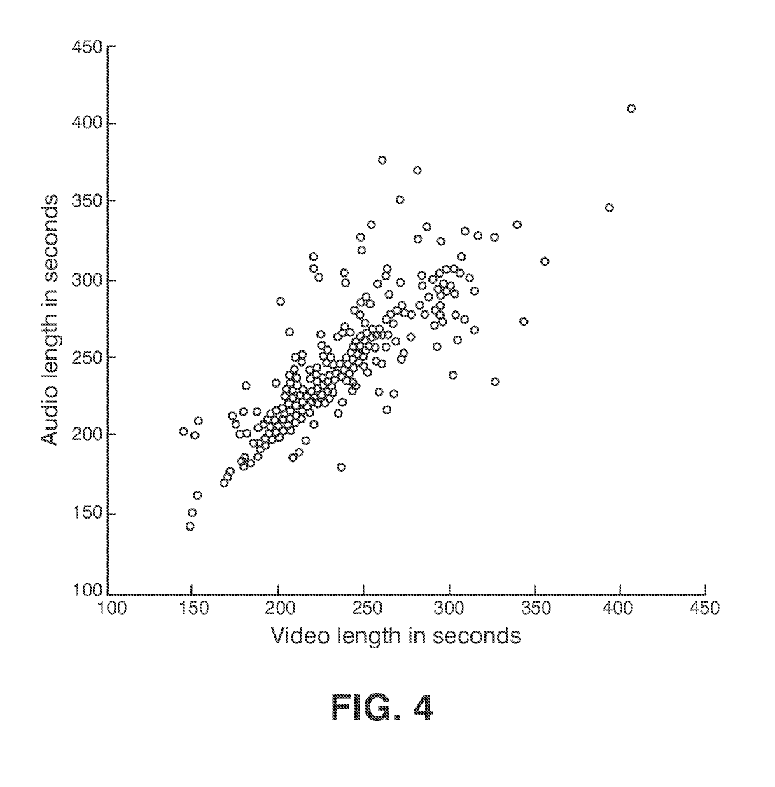

FIG. 4 represents a scatter graph showing the total audio S1 and video S2 durations of the matching pairs in the dataset used. Points away from the diagonal indicate differences between the durations of both files, usually due to differences in the starts or endings or even slight structural variations between the pieces.

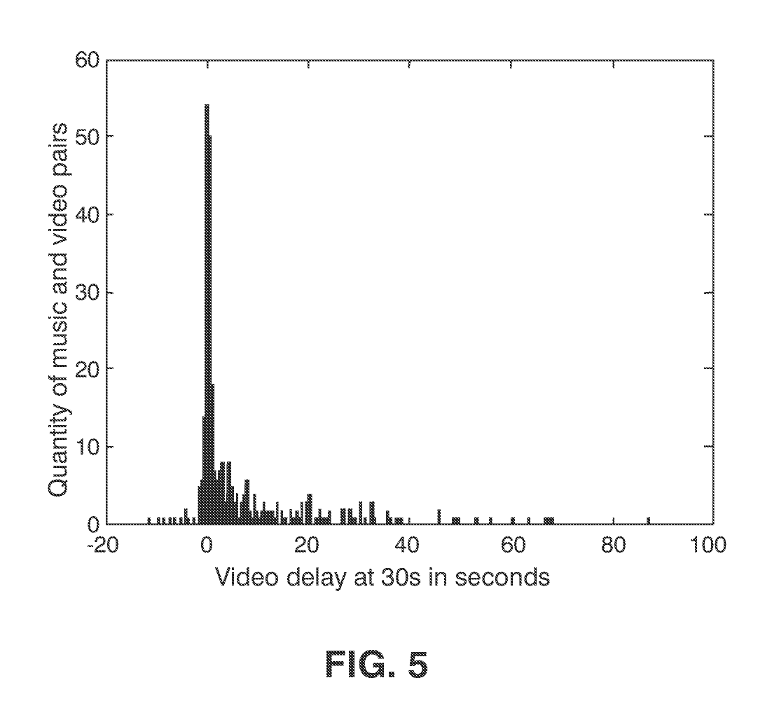

FIG. 5 shows the spread of start time differences, between the matched pairs, given by the offline DTW. The values refer to the delay of the video from the audio and are taken from the DTW alignment at 30 seconds into the audio. This is to ensure that both media have already passed their possibly alternative introductory segments.

In order to evaluate the initial path discovery method, we evaluated the process with varying start times into the music file to simulate a user choosing to synchronise at various points after the audio had begun to play. It could be expected that later start times lead to gains in initial alignment accuracy due to the avoidance of differing starting segments in the sources. In order to assert whether the initial path discovery method was accurate or not, an accuracy requirement of 5 audio frames (0.5 seconds) was established as this was found to be well within the limits for an alignment to be correct thereafter. The accuracy of the different start times varied by a maximum of 2% between starting at 0 seconds (92.8%) and starting at 100 seconds (91.5%). Hence, we conclude the time the alignment was started has little bearing on the performance of the system.

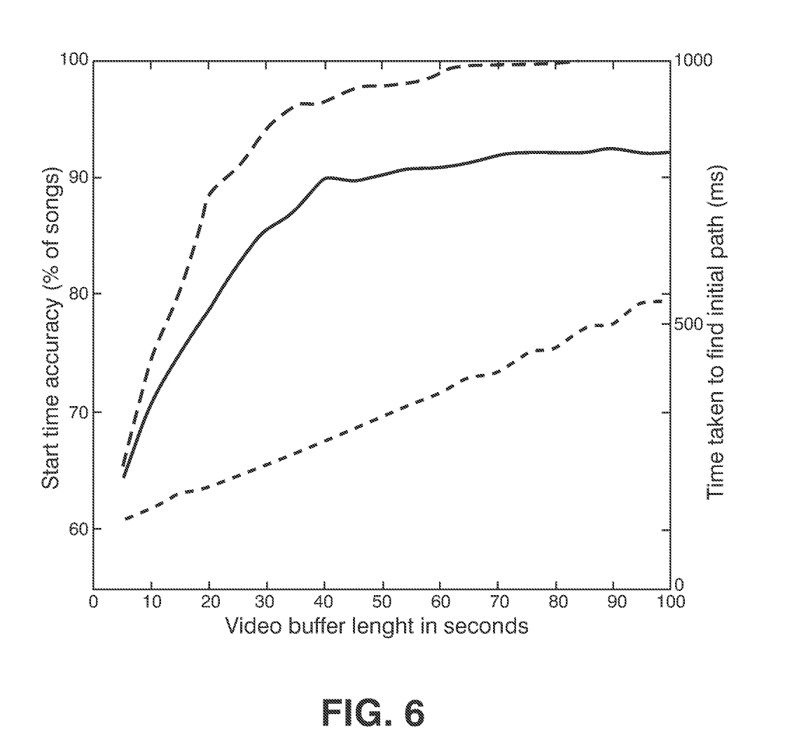

As previously mentioned, most of the musically equivalent start locations are not located at the beginning of the files. However and due to the constraints imposed by the YouTube real-time streaming feature, it is important that the alignment is started before all of the content is obtained. FIG. 6 shows the trade-off between different video buffer lengths used in the initial alignment (X axis), the accuracy, of the initial path discovery (intermediate dashed line) and the time taken to find the initial path (lower dashed line). The theoretical maximum accuracy for different buffer lengths (upper dashed line) is based on how many of the pairs start within any specific buffer length. As expected, the start time accuracy decreases as the video buffer length approaches 0: many videos cannot be initialised at the correct position as the matching music segment hasn't occurred yet within the video buffer. This test allows us to select the appropriate trade-off between the buffering time or downloading requirement and the accuracy of the alignment.

Once the initial alignment is made, the system needs to keep the audio and video in sync despite any deviations from the current playback rate or differences in the musical structure between the pieces. In order to test this property, we recorded the whole path found by the proposed system and compared each frame with the corresponding frame of the known (offline) path. We found that the structurally different pieces had a significant effect on the alignment accuracy of the system. In Table 1 the results of the overall path alignment accuracy are displayed and split into three categories, all pieces, structurally similar pieces and structurally different pieces. The rows show various accuracy requirements or allowable error margin for each step of the alignment path. The columns refer to the how much of the total path alignment steps are within the given accuracy requirement (out of 723 thousand steps). From this test we can see that the number of frames that would be perceived as in sync (according to the typical user sensitivity of 1 frame or 100 ms) was 93.3% for structurally similar pieces and 72.81% for structurally different pieces. Comparing the results between the path discovery and overall alignment it is fair to say that if the path is correctly discovered, there won't be any deviations from the correct path unless there are structural differences present in the music.

TABLE 1
Alignment Accuracy results

| | | Cumulative error counts | | |
|---|---|---|---|---|
| Error≦ | | All Pieces | Similar | Different |
| Frames | Seconds | Frames Hit | Frames Hit | Frames Hit |
| 0 | 0 | 52.02% | 53.69% | 41.26% |
| 1 | 0.1 | 90.55% | 93.31% | 72.81% |
| 2 | 0.2 | 93.07% | 95.89% | 74.94% |
| 3 | 0.3 | 93.23% | 96.02% | 75.27% |
| 5 | 0.5 | 93.38% | 96.14% | 75.63% |
| 10 | 1 | 93.54% | 96.25% | 76.12% |
| 25 | 2.5 | 93.86% | 96.41% | 77.45% |
| 50 | 5 | 94.41% | 96.86% | 78.62% |

From the results of our experiments we chose the buffering limitations for the offline and online options. In the offline case, 80 seconds of the video was chosen to be taken into account when discovering the initial path as this setting allowed for the maximum accuracy of 92% of correct paths hit in our tests (see FIG. 7). For the online case 30 seconds was chosen as this offered a reasonable trade-off in accuracy (86%) and how much video had to be downloaded.

In short, the proposed invention algorithm allows to the user to do a task not available until now with the following advantages.
The initial alignment of the signals to be synchronized allows for the discovery of the starting points where playback is going to start for the video. This alignment is very fast to compute and very accurate. It does not need all the movie nor all the audio, only with a buffer containing the common acoustic content is enough.
The online synchronization of the signals does not require to know the end points of the media and is able to be processed in real time (the only limitation of the system is the download speed of the video in the case of streaming from Internet, which is out of the scope of this invention). The alignment is performed with a series of incremental steps using the standard DTW algorithm in each step, obtaining a good accuracy of alignment while being able to do it in real time. By modifying the parameters of such algorithm it is easy to adapt it to different processing capabilities of the devices running the algorithm, therefore making it viable for a mobile application.
The smoothing of the alignments before application to the video being played back ensures a high quality to the user.

This allows for the creation of new services either at home or for the mobile.

Although the present invention has been described with reference to specific embodiments, it should be understood by those skilled in the art that the foregoing and various other changes, omissions and additions in the form and detail thereof may be made therein without departing from the spirit and scope of the invention as defined by the following claims.

1. A method for real time synchronizing an audio file and a video file in a multimedia device, determining an optimum alignmet path between the audio signal of the audio file and the audio track signal of the video file, the method comprising the following steps:
Retrieving and, initial buffer of the audio signal of the audio file and the audio track signal of the video file
Computing the chroma features of the buffered signals and generating a sequence of first feature vectors U:=(u₁; u₂; . . . ; u_{M}) and second feature vectors V:=(v₁; v₂; ; V_{N}) for the audio signal and the audio track signal of the video file respectively
Finding an initial alignment path Pᵢ=(pᵢ₁ . . . pᵢₖ), between the buffered signals U and V, any path point pᵢⱼ is defined by a pair (mᵢⱼ; nᵢⱼ) which indicates that frames uₘᵢⱼ and vₙᵢⱼ form part of the aligned path.
Starting from the last point of the initial alignment path, apply the following algorithm to obtain an optimum alignment path P=(p₁ . . . p_{w}), any path point pₛ is defined by a pair (mₛ; nₛ) which indicates that frames uₘₛ and vₙₛ form part of the aligned path. Initially P=Pᵢ, the path length W=k and p_{w}:=pᵢₖ:
1. Using the feature sequences of the signals buffered til this moment, computing a forward path P_{f}:=(p_{f1} . . . p_{fL}) with length L by minimizing a defined global cost D, starting at position p_{f1}=p_{w}, where L is a designed parameter. To do so, for each position p_{fs}:=(m_{fs}; n_{fs}), s=1 . . . L−1, the next position p_{fs+1} will be obtained, selecting from this three possible values of p_{fs+1}, (m_{fs}+1, n_{fs}+1), (m_{fs}+1, n_{fs}+2), (m_{fs}+2, n_{fs}+1), the one which minimizes the global cost function D
2. An standard DTW algorithm in which a path with minimizes the defined global cost is found, is applied with starting point p_{fL} and final point p_{f1}. The first half of this path is appended to the optimum alignment path and W=W+L/2
3. If none of the signals has finished, back to step 1
During the algorithm continuing buffering the signals, computing their chroma features, obtaining new feature sequences U and V and using them for steps 1 and 2
Once the optimum alignment path is obtained, smoothing this path, minimizing the jumps between alignment points.

2. A method according to claim 1, where the step of Finding an Initial Alignment path comprises:
a) From every possible position where either the audio or the video are at the initial frame i.e. (U₁, Vₙ) with nε[1: N] or (Uₘ, V₁) with mε[1: M], building a path, adding the best next point for each position, the best next point being selected according to the minimization of the defined global cost.
b) Eliminating all the paths whose overall cost is above the average cost of all the paths. Also, when two paths collide into the same location (m, n) the path with the highest overall cost is discarded.
c) If there is more than one remaining path, adding to each path the next best point and back to paragraph b).
c) When there is only one path remaining, this will be the Initial Alignment Path.

3. A method according to claim 1, where the global cost matrix used is where the defined global cost is calculated at each point as D(m, n)=dU,V (m, n)+min[D(m−1; n−2), D(m−1; n−1), D(m−2; n−1)] being dU,V (m; n) the distance between the m feature vector of the audio signal, uₘ and the n feature vector of the video signal vₙ

4. A method according to claim 3, where the distance dU,V (m, n) is calculated as
$$d U , V ( m , n ) = 1 - \frac{〈 {u}_{m} , {v}_{n} 〉}{‖ {u}_{m} ‖ ‖ {v}_{n} ‖}$$

5. A method according to claim 1 where the step of smoothing the path comprises the following steps:
Every time the video signal is updated with a new frame, computing the time difference between the video and the audio by the projected alignment path.
Averaging the differences over a certain period of time is calculated.
If the averaged time difference differs from the video's actual difference, as known by the media player, by more than a certain threshold, skipping or replaying video frames are skipped or replayed until the correct difference between the video and audio is reached.

6. A method according to claim 5 where the certain period of time is 5 seconds

7. A method according to claim 5 where the certain period of time is 35 milliseconds seconds

8. The method of claim 1 where the audio file is a music file and the video file is its counterpart music video file.

9. The method of claim 1 where the method is implemented by a multimedia device.

10. A method according to claim 9 of the previous claims where the multimedia device is a desktop computer, a set-top box or a mobile phone.

11. A method according to claim 9 where the audio file is locally stored in the multimedia device or being streaming in real time from the internet.

12. A method according to claim 9 where the audio file is being recorded through a microphone of the multimedia device.

13. A method according to claim 9 where the video file is locally stored in the multimedia device or being streaming in real time from the internet.

14. A method according to claim 1 where L is set to 50.

15. A system comprising means adapted to perform the method according to claim 1.

16. A computer program comprising computer program code means adapted to perform the method according to claim 1 when said program is run on a computer, a digital signal processor, a field-programmable gate array, an application-specific integrated circuit, a micro-processor, a micro-controller, or any other form of programmable hardware.
